(19) United States
(12) Patent Application Publication
(10) Pub. No.: US 2021/0160790 A1
(43) Pub. Date: May 27, 2021

(54) SELECTIVE TRANSMISSION POWER CONTROL

(71) Applicant: AMIMON LTD., Ra'anana (IL)

(72) Inventors: Zvi REZNIC, Tel Aviv (IL); Igal PORTNOY, Tel Aviv (IL)

(21) Appl. No.: 16/610,506

(22) PCT Filed: May 10, 2018
(86) PCT No.: PCT/IB2018/053245

§ 371 Date: Nov. 3, 2019

Related U.S. Application Data
(60) Provisional application No. 62/507,817, filed on May 18, 2017.

(51) Int. Cl. H04W 52/34; H04W 52/24; H04L 27/26

(52) U.S. Cl. CPC H04W 52/346; H04L 27/2602; H04W 52/245

(57) ABSTRACT

A method for wireless transmission the method includes differentiating between at least a first type of video data and a second type of video data, where at least the first video type is more important than the second video type. The method provides independently controlling the amounts of transmission power allocated to each of the types of data; and multiplexing and transmitting the types of data with their allocated amounts of transmission power.

### CROSS-REFERENCE TO RELATED APPLICATIONS

This application claims priority from U.S. Provisional Patent Application No. 62/507,817, filed 18 May 2017, which is hereby incorporated in its entirety by reference.

### FIELD OF THE INVENTION

The present invention relates to transmission power control generally and to selective transmission power control in particular.

### BACKGROUND OF THE INVENTION

First-person view (FPV) racing, an exciting sport that combines high-tech drones and high-speed racing, has become increasingly common and is a fast growing activity amongst remote controlled (RC) aircraft enthusiasts. In FPV, the radio-controlled vehicle is controlled from the driver or pilot's view point and is most commonly used to pilot a radio-controlled aircraft or other type of unmanned aerial vehicles (UAV) such as drones.

The vehicle is either driven or piloted remotely from a first-person perspective via an onboard camera, fed wirelessly to special video FPV goggles or to a video monitor. The video, taken by the onboard camera, is transmitted from the airborne component using a wireless (radio) technology.

In FPV racing, many racers are located at approximately the same location, and each racer uses a different channel for his video transmission. The close proximity of the receivers and transmitters of all users may cause interference in the received signals, a phenomenon called inter-channel-interference (ICI), when some of the transmitted power from one channel may leak to a neighboring channel.

The ICI level, measured in dBm, depends linearly on the transmitted power of the interfering station: a lower transmission power may result in a lower (better) ICI while a higher transmission power may result in a higher (inferior) ICI. On the other hand, the wireless link range is proportional to the transmission power; a lower transmission power may result in a smaller wireless link range, while a higher transmission power may result in a greater wireless link range. It may be appreciated that the adjustment of the transmission power level is a non-trivial task as each change in the transmission power (up or down) may have an incompatible impact on the quality and range of the transmission.

Transmission power control (TPC) is a mechanism used in radio communications to reduce the power of a radio transmitter to the minimum necessary to maintain the link with a certain quality. TPC is used to avoid interference between devices and/or to extend the battery life. Network devices supporting this feature include IEEE 802.11h Wireless LAN devices in the 5 GHz band compliant to the IEEE 802.11a.

The idea of the TPC mechanism is to automatically reduce the used transmission output power when the wireless link range is short and the received power is high. As already mentioned reduced transmission power implies reduced interference problems and increased battery capacity. In the standard TPC mechanism, the transmission power is reduced in small steps, such as 1 dB per step, which results in a large management overhead in the devices implementing TPC.

On the other hand, reducing the power in big steps, such as 6 dB (as also described in the standard), may result in loss of connectivity between the transmitter and the receiver if the receiver becomes out of range when the power is decreased, an unwelcome situation.

The big step power reduction should therefore be performed very conservatively, with large margins, to avoid the risk of not having enough power to maintain the link between the transmitter and the receiver, a situation that may result in a disconnection of the link once the power is reduced. The conservative reduction of transmission power may not minimize the ICI as much as possible and may reduce the overall effectiveness of the TPC mechanism.

In the case of FPV, since the drone flies rapidly and its distance from the receiver may vary rapidly, the drone may reduce transmission power just before the distance from the receiver is increased, a situation that may result in a disconnection of the link between the drone and the receiver and the loss of control of the drone.

### SUMMARY OF THE PRESENT INVENTION

There is provided in accordance with a preferred embodiment of the present invention a method for wireless transmission. The method includes differentiating between at least a first type of video data and a second type of video data, where at least the first video type is more important than the second video type, independently controlling the amounts of transmission power allocated to each of the types of data; and multiplexing and transmitting the types of data with their allocated amounts of transmission power.

In addition, in accordance with a preferred embodiment of the present invention, the multiplexing is via OFDM.

Moreover, in accordance with a preferred embodiment of the present invention, the first type of data is coarse bins and the second type of data is fine bins.

Furthermore, in accordance with a preferred embodiment of the present invention, an amount of power per bin allocated to the coarse bins is higher than an amount of power per bin allocated to the fine bins.

Still further, in accordance with a preferred embodiment of the present invention, bins at an edge of a channel are defined as one of the types of data.

And still further, in accordance with a preferred embodiment of the present invention, the method also includes receiving a receiver power state indication and the controlling is according to the receiver power state indication.

Moreover, in accordance with a preferred embodiment of the present invention, the method also includes sending the power levels to each of said types of video as a TPC state indication.

There is provided in accordance with a preferred embodiment of the present invention a system for wireless transmission. The system includes a video encoder and mapper to differentiate between at least a first type of video data and a second type of video data, where at least the first video type is more important than the second video type. The system also includes a selective TPC controller to independently control the amounts of transmission power allocated to each of the types of data and an RF unit to multiplex and transmit said types of data with their allocated amounts of transmission power.

Moreover, in accordance with a preferred embodiment of the present invention, the multiplexing is via OFDM.

Furthermore, in accordance with a preferred embodiment of the present invention, the first type of data is coarse bins and the second type of data is fine bins.

Still further, in accordance with a preferred embodiment of the present invention, an amount of power per bin allocated to the coarse bins is higher than an amount of power per bin allocated to the fine bins.

Still further, in accordance with a preferred embodiment of the present invention, bins at an edge of a channel are defined as one of the types of data.

Furthermore, in accordance with a preferred embodiment of the present invention, the selective TPC controller to receive a receiver power state indication and to control the amounts of transmission power according to the receiver power state indication.

Additionally, in accordance with a preferred embodiment of the present invention, the selective TPC controller to send an indication of the amounts of transmission power.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an illustration of an FPV system constructed and operative in accordance with a preferred embodiment of the present invention;

FIG. 2 is an illustration of a video transmitter, constructed and operative in accordance with a preferred embodiment of the present invention;

FIG. 3 is an illustration of a state machine to control the power level of the transmission constructed and operative in accordance with a preferred embodiment of the present invention;

FIG. 4 is a schematic illustration of a video receiver constructed and operative in accordance with a preferred embodiment of the present invention; and

FIG. 5 is a schematic illustration of a video transmitter, constructed and operative in accordance with an alternative embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that the division of video to coarse and refinement streams, as detailed in U.S. Pat. No. 8,559,525 entitled “APPARATUS AND METHOD FOR UNCOMPRESSED WIRELESS TRANSMISSION OF VIDEO”, assigned to the common assignee of the present invention, may be exploited to reduce the ICI while maintaining sufficient range and enabling channel re-use, when implementing a selective TPC mechanism.

In the above mentioned U.S. Pat. No. 8,559,525, video is divided into coarse and refinement streams, where the coarse stream includes the most important information and the refinement stream includes the less important information.

Applicant has realized that it is possible to control the power of each data type separately such that the high importance stream is transmitted with high power and the low importance stream is transmitted with low power. Providing a different power level to different datatypes may reduce the probability of losing important information while still reducing the overall power of the entire transmission.

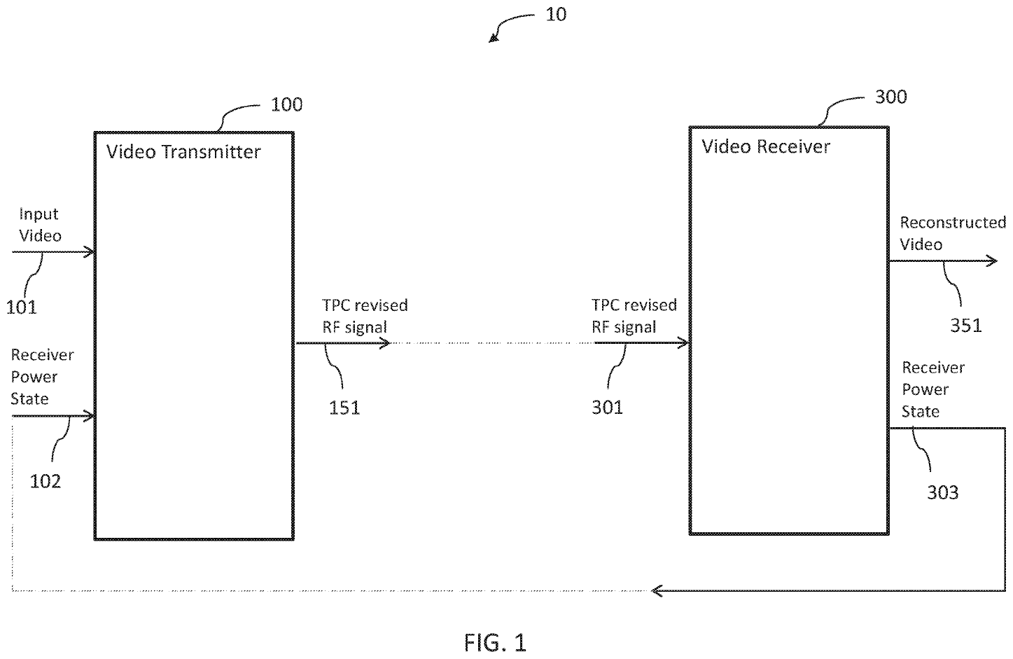

Reference is now made to FIG. 1, which schematically illustrates an FPV system 10 comprised of a video transmitter 100 and a video receiver 200, constructed and operative in accordance with a preferred embodiment of the present invention. Video transmitter 100 may receive the video in input video 101 and may transmit a TPC revised RF signal 151 and may optionally transmit a TPC state indicating the TPC state of the current transmission. Video transmitter 100 may receive a receiver power state signal 102, indicating the power of the signal received by video receiver 200. Video receiver 200 may receive a TPC revised RF signal 301 and optionally receive a TPC state indication and may rebuild reconstructed video 351. Video receiver 300 may create and transmit a receiver power state 303 indicated the power level of the received signal.

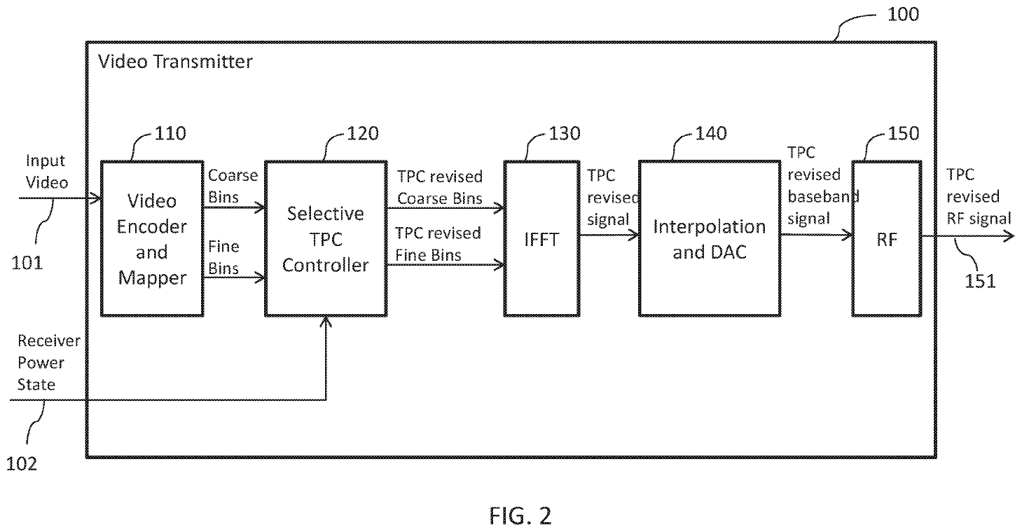

Reference is now made to FIG. 2, which schematically illustrates the details of video transmitter 100, constructed and operative in accordance with a preferred embodiment of the present invention. Video transmitter 100 comprises a video encoder and mapper 110, a selective TPC controller 120, an inverse fast Fourier transform module 130, an interpolation digital-to-analog converter (DAC) module 140, and a radio frequency (RF) unit 150.

Video encoder and mapper 110 may allocate different bins or symbols to different types of data in input video 101. As defined in U.S. Pat. No. 8,559,525, these may be coarse bins and fine bins.

Selective TPC controller 120 may allocate different power levels to the different bins. The power level allocation may depend on momentary external conditions, as perceived from a received receiver power state indications 102, received by selective TPC controller 120 and on the type of the bins to be transmitted.

Receiver power state indication 102 may indicate the power level of the signals as received by the receiver, which may imply the distance between transmitter 100 and receiver 300. The type of a bin, coarse bin or fine bin, may be provided by video encoder and mapper 110.

Selective TPC controller 120 may provide an initial power level to the bins. This power level may be known and agreed upon between transmitter 100 and receiver 300 in advance. It may be appreciated that selective TPC controller 120 may implement any power allocation scheme. As an example, the same power level, which may be the maximum available power level, may be initially allocated to both coarse and fine bins, but any other level of power may be initially provided to any bin type.

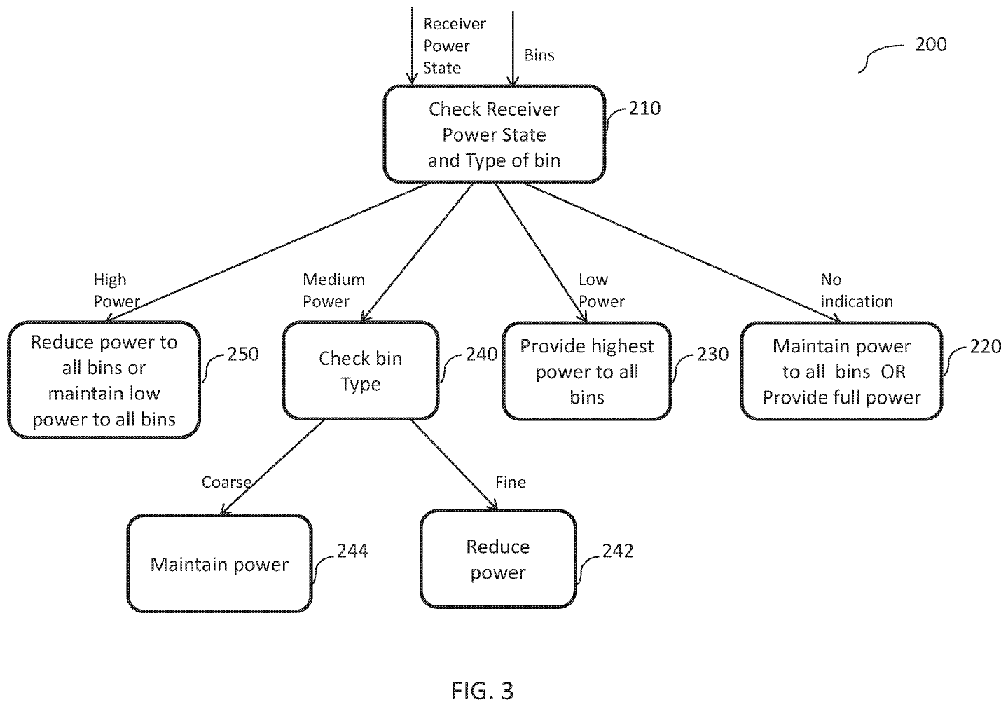

During the operation of video transmitter 100, selective TPC controller 120 may check the received receiver power state indication 102 and may gradually increase or decrease the power allocated to different parts of the transmission in response. The power step size for increasing and/or decreasing may be any value, such as 1 dB, 2 dB, 3 dB, 4 dB, 5 dB, 6 dB and the like. It may be appreciated that the step size for increasing may differ from the step size for decreasing, for example, the step size for increasing may be 6 dB while the step size for decreasing may be 2 dB. The actual change made to the power allocation may be indicated by a TPC state indication, which may be transmitted along with the transmitted data inside the TPC revised coarse bins that may carry the TPC state, in addition to the coarse video description. The operation of selective TPC controller 120 is detailed hereinbelow, with respect to FIG. 3.

IFFT 130 may be any standard inverse fast Fourier transform module. Interpolating DAC 140 may be any standard module capable of shaping and converting the digital signal to an analog signal. RF unit 150 may be any standard module capable of transmitting a wireless RF signal 151.

FIG. 3, to which reference is now made, schematically illustrates a state machine 200 implemented by selective TPC controller 120 to control the power level of the transmission. The power level may be a function of the distance the transmission needs to traverse and the type of data to be transmitted. State machine 200 may implement a different functionality for any possible combination of distance and data. In state 210, selective TPC controller 120 may receive and check the momentary conditions as expressed by receiver power state indication 102, and the type of the received bin.

When selective TPC controller 120 does not receive any receiver power state indication 102, it may move to state 220, where it may allocate power to the bins without any current knowledge of the external conditions. In this case, selective TPC controller 120 may allocate full power to all bins, since no knowledge regarding the current external conditions may indicate a large distance. Alternatively, in state 220, selective TPC controller 120 may keep allocating the same power level previously allocated to the different bins, until the external conditions may be perceived again from receiver power state indication 102 received by selective TPC controller 120.

The value of receiver power state indication 102 may be low, medium or high. When the value of receiver power state indication 102 is low (e.g. below −65 dBm), the transmitted signal is weak, possibly indicating a long distance between transmitter 100 and receiver 300. In this case, selective TPC controller 120 may move to state 230 in which it may allocate maximum power to all bins, providing full power to the entire transmission.

When the value of receiver power state indication 102 is medium (e.g. between −65 dBm and −55 dBm), selective TPC controller 120 may move to state 240 in which it may check the type of the bin. When the type of the bin is fine, selective TPC controller 120 may move to state 242 in which it may reduce the power of the fine streams by one step. The step size may be any size, as already discussed hereinabove. When the type of the bin is coarse, selective TPC controller 120 may move to state 244 in which it may maintain the power of the bin as in previous transmission.

When the value of receiver power state indication 102 is high (e.g. above −55 dBm), selective TPC controller 120 may move to state 250 in which it may reduce the power of all stream types, both the fine and the coarse streams.

In all states, TPC controller 120 may change the power of the different bins with a different step size, or it may change only the power of specific bin types. Additionally or alternatively, a different step size may be utilized when increasing the power and when decreasing the power.

It may be appreciated that selective TPC controller 120 may change the power level at any rate. The minimum rate change is zero. For example, if the range between transmitter 100 and receiver 300 is fixed, and there are no changes in the receiver power state indication 102, TPC controller 120 may choose not to change the power level allocated to the bins. The maximum rate of change may be implementation dependent. For example, the power level may be defined once per video frame, or once per N video frames, once per received receiver power state indication 102 and the like.

It may be appreciated that the details of state machine 200, including the explicit number of states and the transition between steps, are merely an example. State machine 200 may have more or less states, the functionality in each step and the transition between steps may differ from those described in the example of FIG. 3.

In addition to the transmitted stream, TPC controller 120 may send a TPC state signal indicating the change in power provided to bins, the amount of increase or decrease of power to each data type

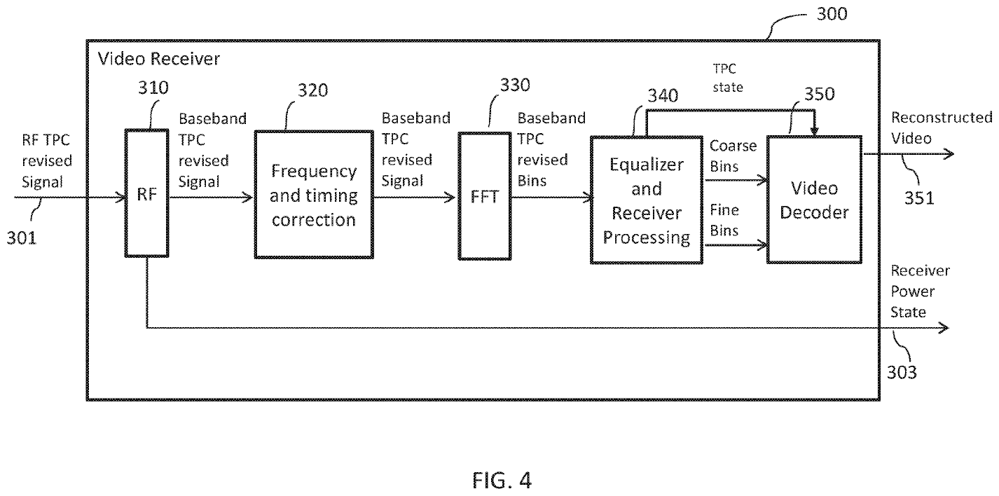

FIG. 4, to which reference is now made, is a schematic illustration of video receiver 300, constructed and operative in accordance with a preferred embodiment of the present invention. Video receiver 300 may comprise an RF unit 310, a frequency and timing correction module 320, a fast Fourier transform module (FFT) 330, an equalizer and receiver processing 340 and a video decoder 350.

RF unit 310 may be any standard module capable of receiving wireless RF signals (e.g. RF TPC revised signal 301 and TPC state indication) and measuring the power of the received signal. Frequency and timing correction module 320 may be any standard module capable of provide frequency and timing corrections. FFT 330 may be any standard fast Fourier transform module.

Equalizer and receiver processing 330 may extract the bins from the received signals and may measure their power. It may then send the coarse and fine bins to video decoder 350, which may reconstruct video 351 from the received signals. Video receiver 300 may compare the power of the received signal (Rx power) with the expected value and may send an indication regarding the perceived power value. The perceived power value may be received by transmitter 100 (of FIG. 1) that may respond to it as described hereinabove with respect to FIG. 3.

Video Receiver 300 may be aware of the decision thresholds of transmitter 100 and may send an indication only when such information may cause transmitter 100 to change the power level of the transmission. It may not be necessary to send any indication or feedback when a change is not anticipated. Additionally or alternatively, video receiver 300 may send an indication periodically, e.g. once per video frame, once per N video frames, etc.

It may be appreciated that video receiver 300 may support any of the following transmission methods: MIMO, SISO and SIMO.

Moreover, the allocation of bins to fine and coarse streams may be controlled by video encoder and mapper 110 of FIG. 2 that may allocate the high frequency bins to the fine stream, to further improve the ICI when the fine stream power is reduced. For example, for a carrier F and bandwidth 20 MHz, bins at F+9.5 MHz and F−9.5 Mhz may be considered “high frequency bins”, since they are at the band edges, far away from the carrier frequency, and bins at F+0.3 MHz and F−0.3 Mhz may be considered “low frequency bins”, since they are close to the carrier frequency. In this case, high frequency video encoder and mapper 110 may use a specific allocation scheme that allocates high frequencies to “fine” bins.

It may be appreciated that using the method described hereinabove for real time dynamic adaptation of the transmission output power according to external momentary conditions may significantly reduce interference problems, may increase battery capacity and may decrease the chance to lose connectivity between transmitter 100 and receiver 300, as power is gradually decreased. Moreover, the method of the present invention may decrease the chance to lose information in the transmission since the power is decreased only to the part of the transmission that includes less important information. If the signal with the less important information get attenuated or lost, it may not significantly decrease the overall quality of the transmission since important information may still be transmitted with high power, which is less likely to get lost.

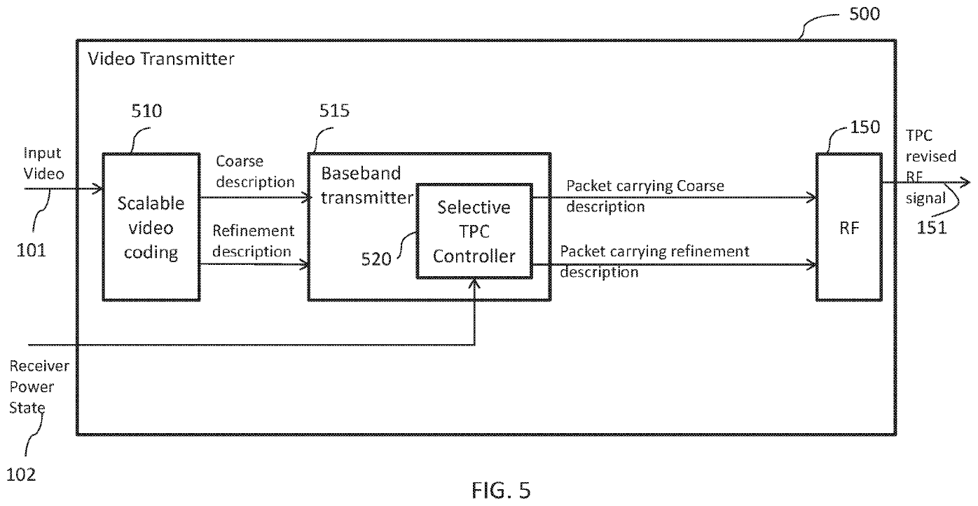

It may also be appreciated that input video 101 may be coded with different scalable video coding schemes, such as H.264 SVC as described in FIG. 5 to which reference is now made. Video transmitter 500 comprises a standard scalable video coding module 510, a standard baseband transmitter 515 and an RF unit 150. Baseband transmitter 515 further comprises a selective TPC controller 520 that may provide different power levels to different data. The revised data may be relayed to RF transmitter 150 which may transmit the data over a wireless radio frequency. It may also be appreciated that RF transmitter 150 may send different data types using different packets. Using dedicated wireless packets to send different data types may be exploited by selective TPC controller 120 which may, for example, at medium range, reduce the power of the packets that carry the refinement video stream.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a general purpose computer of any type such as a client/server system, mobile computing devices, smart appliances or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. The resultant apparatus when instructed by software may turn the general purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for wireless transmission, the method comprising:
differentiating between at least a first type of video data and a second type of video data, wherein at least said first video type is more important than said second video type;
independently controlling the amounts of transmission power allocated to each of said types of data; and
multiplexing and transmitting said types of data with their allocated amounts of transmission power.

2. The method of claim 1, wherein said multiplexing is via Orthogonal frequency-division multiplexing (OFDM).

3. The method of claim 2 wherein said first type of data is coarse bins and said second type of data is fine bins.

4. The method of claim 3, wherein an amount of power per bin allocated to said coarse bins is higher than an amount of power per bin allocated to said fine bins.

5. The method of claim 3, wherein bins at an edge of a channel are defined as one of said types of data.

6. The method of claim 1, and also comprising receiving a receiver power state indication and wherein said controlling is according to said receiver power state indication.

7. The method of claim 1, and also comprising sending the power levels to each of said types of video as a TPC state indication.

8. A system for wireless transmission, the system comprising:
A video encoder and mapper to differentiate between at least a first type of video data and a second type of video data, wherein at least said first type of video is more important than said second type of video;
a selective TPC controller to independently control an amounts of transmission power allocated to each of said types of data; and
an RF unit to multiplex and transmit said types of data with their allocated amounts of transmission power.

9. The system of claim 8, wherein said multiplexing is via OFDM (Orthogonal frequency-division multiplexing).

10. The system of claim 9 wherein said first type of data is coarse bins and said second type of data is fine bins.

11. The system of claim 10, wherein an amount of power per bin allocated to said coarse bins is higher than an amount of power per bin allocated to said fine bins.

12. The system of claim 10, wherein bins at an edge of a channel are defined as one of said types of data.

13. The system of claim 8 wherein said selective TPC controller to receive a receiver power state indication and to control said amounts of transmission power according to said receiver power state indication.

14. The system of claim 8 wherein said selective TPC controller to send an indication of said amounts of transmission power.
